(19) United States
(12) Patent Application Publication
(10) Pub. No.: US 2011/0006272 A1
(43) Pub. Date: Jan. 13, 2011

(54) Electrochromic films prepared by supramolecular self-assembly

(75) Inventors: Bernd Tieke, Bruhl (DE); Anna Maier, Koln (DE); Aravinda Raman Rabindranath, Koln (DE)

Correspondence Address: BASF Corporation;Patent Department, 500 White Plains Road, P.O. Box 2005, Tarrytown, NY, 10591, US

(73) Assignee: BASF SE, Ludwigshafen (DE)

(21) Appl. No.: 12/640,203

(22) Filed: Dec. 17, 2009

Related U.S. Application Data
(60) Provisional application No. 61/203,118, filed on Dec. 18, 2008.

(51) Int. Cl. G02F 1/061; B05D 5/12; B05D 5/06

(52) U.S. Cl. 252/583; 427/126.2

(57) ABSTRACT

Highly active and durable electrochromic films are prepared with good thickness control in the nanometer range by alternate application of a metal salt solution and a solution of a π-conjugated polymer having metal complexing side chains, for example, polymers having side chains comprising terpyridine (tpy) groups. Thus a robust, crosslinked organo-metallic network of a known, desired thickness with excellent electroactive properties is readily prepared.

This application claims benefit under 35 USC 119(e) of U.S. provisional application No. 61/203,118, filed Dec. 18, 2008, incorporated herein in its entirety by reference.

Ultra thin, durable, electroactive films comprising three dimensional networks of metal ion complexes of π-conjugated polymers are formed on a substrate, with excellent control of film thickness, by sequential exposure, for example by immersion, of the substrate to a solution of a metal salt and then a solution of a π-conjugated polymer containing metal complexing side chains, for example, polymers having side chains comprising terpyridine (tpy) groups. The films thus prepared, in particular films prepared using polymers wherein the metal complexing side chain groups are conjugated with the polymer backbone, are highly porous enabling rapid ion transfer which allows for rapid switching time when incorporated into, for example, as a color changing material in an electrochromic device.

### BACKGROUND OF THE INVENTION

Electroactive polymers have attracted a great deal of attention due to their promising applications as functional materials for conductive materials, light-emitting diodes, electrochromic devices, field effect transistors, photovoltaic devices, batteries, antistats etc. For example, electrochromic polymers are used in a variety of electronic devices.

Electrochromic materials and devices are well known, e. g., U.S. Pat. Nos. 4,902,108 and 6,178,034, incorporated herein in their entirety by reference, and are typically associated with a noticeable change in color. However, changes in other optical properties, such as in the degree of clarity and opacity and absorption in the IR, are also characteristics of such devices. Such devices undergo a reversible change in electromagnetic radiation transmission upon application of an electrical stimulus, for example, via electrochemical oxidation or reduction reactions, and are currently found in applications such as glazings, e.g., energy efficient and privacy windows for architectural or automotive use, automotive rearview mirrors, displays, filters, eyewear, antidazzle and fog penetrating devices, and other applications where variable light transmission is desired.

Many of these devices incorporate working elements that comprise contiguous layers of functional materials, e.g., electrodes, color changers, electrolytes etc. Electrochromic materials with film-forming properties, for example, film forming electrochromic polymers, can offer many advantages in the preparation of such working elements.

Materials based on organic polymers offer certain advantages over inorganic materials in such devices. For example, polymers are often handled easily in air and can be molded, applied or processed using conventional techniques well known in conventional plastic and coating applications. For example, polymeric films can be formed on an electrode or other part of a device by spin-coating, solvent evaporation, ink jet techniques, electrochemical deposition, compression molding, or layer-by-layer assembly. The latter method is advantageous because it can be used to assemble ultrathin films of a variety of organic and inorganic compounds in a simple and inexpensive manner with thickness control in the nanometer range.

U.S. Pat. No. 6,791,738, incorporated herein in its entirety by reference, provides electrochromic polymers, in particular, anodically coloring poly 3,4-dialkoxypyrroles, and electrochromic devices comprising them.

U.S. Pat. No. 5,446,577, incorporated herein in its entirety by reference, discloses display devices comprising a transparent outer layer and a reflective ion-permeable electrode which is capable of changing reflectance and/or color by the application of an electric potential to the electrodes.

U.S. Pat. No. 5,995,273, incorporated herein in its entirety by reference, discloses an electrochromic display device having an electrochromic conducting polymer layer in contact with a flexible outer layer.

There are also potential disadvantages in using conductive polymers. For example, many electrochromic applications place the electrochromic polymer in the presence of electrolyte systems which may include aggressive solvents. Poor contact with, for example, an electrode, or subsequent polymer delamination will negatively impact or negate the desired electrochromic behavior. Therefore, good adhesion of the polymer to the surface of the electrode or other layer must be attained and retained. The same solubility characteristics that allow a polymer to be applied as a coating may also result in a greater degree of polymer dissolution or delamination.

It is possible to combine both inorganic and organic moieties in the functional layers of electroactive devices.

U.S. Pat. No. 6,838,198, incorporated herein in its entirety by reference, discloses self assembling, layered, organic/inorganic-oxide materials based on layers of tungsten oxide, molybdenum oxide or other metal oxides alternating with organic layers to form a multilayer planar structure, prepared, for example, by reaction of a diaminoalkane with tungstic acid or molybdic acid. The materials are suitable for electronic applications such as flexible displays, electrochromic devices, sensors and logic and storage devices. The organic layers may be made of conductive organic polymers and comprise compounds having groups which can bind to the metal oxide.

U.S. Pat. No. 7,435,362, incorporated herein in its entirety by reference, discloses redox-switchable material comprising a redox-active moiety, for example a ferrocene, acridine, or quinone, adsorbed and/or, bonded to a semiconductor material useful in photoerasable writing media, electrochromic or photochromic materials, catalysis, and solar energy storage.

U.S. Pat. No. 6,224,935, incorporated herein in its entirety by reference, discloses interfacially reacting a functionalized dendrimer or bridging ligand, e.g., terpyridyl-pendant poly-amido amine starburst dendrimers, in a solution of a water immiscible solvent with an aqueous solution of transition metal ions in the presence of a substrate to obtain an ordered film on the surface the substrate. “Interfacially reacting” means that the reaction occurs at the solvent/water interface which limits the reaction to two dimensions to enhance film formation.

U.S. Pat. Nos. 7,414,188 and 7,094,441, incorporated herein in entirety by reference, disclose the use of an organometallic linking agent, poly(n-butyl titanate), to link inorganic particles in the production a thin, electroactive film on, for example, indium tin oxide.

U.S. Pat. No. 7,445,845 discloses multi-chromophoric Zn(II) metal complexes useful in nonlinear optical devices and other optoelectronic applications. Electroactive organo/metallic systems are also found in biomaterials, e.g., U.S. Pat. Nos. 7,384,749 and 7,297,290.

Sequential application of metal salts and electroactive polymers can produce films of three dimensional organo-metallic networks which reversibly change color in the presence of applied voltage. Typically, film formation is brought about by alternating electrostatic assembly of electroactive components and non-active counter-polyelectrolytes using the layer-by-layer technique of Decher and coworkers (as in Thin Solid Films, 1994, 244, 772). Previous work has demonstrated preparation of electrochromic layer-by-layer assemblies using polymers containing redox-active viologen or triphenylamine units, conjugated polyelectrolytes such as polythiophene derivatives and polyaniline, or colloidal solutions of Prussian Blue nanoparticles.

It has now been found that a cross-linked organic-inorganic coordination polymer with excellent electrochromic properties can be stepwisely built up using a layer by layer approach on a solid support with excellent thickness control and without the need for a counter-polyelectrolyte.

### SUMMARY OF THE INVENTION

Highly active and durable electrochromic films are prepared with thickness control in the nanometer range by alternate application of a metal salt solution and a solution of a π-conjugated polymer having metal complexing side chains, for example, polymers having side chains comprising terpyridine (tpy) groups. The steps are optionally repeated as desired. Each iteration of the process, i.e., application of the metal salt layer and π-conjugated polymer solutions, yields a film layer with reproducible thickness. Therefore, repeating the steps allows one to sequentially assemble a robust, crosslinked organo-metallic network of a known, desired thickness.

The method provides a supramolecular self-assembly process for the preparation of ultrathin electrochromic films comprising inorganic metal ions in a coordination polymer matrix without the aid of non-electroactive counter-polyelectrolytes. Excellent results are obtained using polymers wherein the metal complexing side chains, for example tpy groups, are conjugated with the polymer backbone. The sequential assembly of films is favored by the polyfunctional character of the polymer chains acting as polytopic ligands which provide a high concentration of tpy groups at the substrate surface, which again favors the immobilization of metal ions in high concentration and so on.

The metal ion coordination of the polymer chains thus leads to an insoluble cross-linked structure which is especially advantageous for electrochromic switching as desorption of individual polymer chains becomes highly unlikely.

The method allows for the use of salts of almost any metal that forms a stable solution. Good results are obtained using metal hexafluorophosphate salts, for example, hexafluorophosphate salts of transition metals. One particular embodiment provides electrochromic films of zinc, nickel, or cobalt polyiminofluoreneterpyridine.

The invention also provides a method wherein the metal ion of the initially prepared coordination polymer is exchanged with an alternate metal by exposure of the coordination polymer to an appropriate solution of a salt of the alternate metal ion, typically by immersion of the coordination polymer into a solution of the alternate metal ion.

### DETAILED DESCRIPTION OF THE INVENTION

A method is provided for preparing electrochromic films on a substrate, which method comprises contacting at least one surface of the substrate with a solution of a metal salt to produce a metal salt treated surface and in a separate step contacting the metal salt treated surface with a solution of a π-conjugated polymer which polymer comprises a repeating unit of the formula

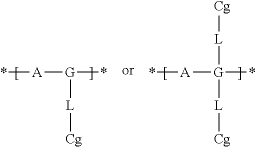

wherein A is an aromatic or heteroaromatic containing unit, for example, a unit found as a repeating unit in electrochromic polymers, G is a moiety which allows for the metal complexing agent to be linked to, and in many cases conjugated with, the backbone of the polymer, L is a linking group linking Cg to G, often allowing Cg to be conjugated through G with the polymer backbone, and Cg is a metal complexing agent typically selected from anilines, pyridines, bipyridines, terpyridines, pyrroles, other polypyridyls, polypyrroles, imidazole, Schiff bases, salicylideneamines, triazoles, diazines, triazines, dipyrrins and phenanthrolines. In one embodiment, Cg is a conjugated metal complexing agent and is conjugated through L and G with the backbone of the polymer.

Other embodiments of the invention include the electrochromic film produced by the method, the substrate coated with the film and devices comprising them.

The substrate upon which the film is prepared is not limited by the invention and can be comprised of almost any stable, solid material, for example, an organic polymer such as a naturally occurring polymer or a synthetic polymer such as a thermoplastic polymer, a metal, a mineral such as quartz, glass, ceramic or other material. In one embodiment, such as for use in an electrochromic device, the film may be prepared directly on an electrode, for example, a layer of indium tin oxide on a glass or other substrate.

The surface of the substrate may be optionally pre-treated prior to contacting the metal salt and polymer solutions of the method. For example, the surface of the substrate may be rigorously cleaned with aggressive solvents, caustic materials or abrasives, or the surface may be treated in a manner which leads to the formation of ions on the surface.

In one embodiment of the invention, the surface of the substrate upon which the electrochromic film is prepared is pretreated to form a negatively charged surface prior to exposure of the surface to the solution of the metal salt. For example, polyelectrolyte layers such as layers of polystyrene sulfonate and polyethyleneimine may be applied.

The surface of certain substrates may also undergo additional pretreatments, for example, quartz substrates may be silanized with 3-aminopropylmethyldiethoxysilane prior to application of the polyelectrolyte layers.

In the method, the optionally pretreated substrate is conveniently immersed or dipped into the metal salt solution for a selected period of time, removed, and then immersed or dipped into the polymer solution for a selected period of time and then removed. Typically, the substrate is washed in a solvent mixture, for example, by immersion or dipping in a solvent, after removal from the metal salt or polymer solution. The sequence may be repeated until a film of the desired thickness is prepared.

Immersion or dipping is not the only means of contacting the surface of the substrate to the metal salt and polymer solutions and other means well known in the coatings art may be employed, e.g., spraying, drop casting, spin coating, draw down, etc. However, immersion or dipping for a specific period of time is a simple and reproducible process and is the means comprised by a particular embodiment of the invention.

The amount of time the substrate is immersed in either of the solutions will vary depending on the composition and concentration of the solutions. The selection of solvent or solvent mixture has been found to be very important, but such optimization is well within the skill of the practitioner in light of the disclosure herein. Substrates can be immersed for hours but typically less than 1 or 2 hours, generally from about 1 second to about 30 minutes, often from about 1 second to about 15 minutes.

For example, the method comprises a sequence of steps wherein the substrate is optionally pre-treated and then

i) immersed into the solution of a metal salt for a selected period of time, removed, then

ii) immersed into a rinsing solvent for a selected period of time, removed, then

iii) immersed into the solution of the a π-conjugated polymer for a selected period of time, removed, then

iv) optionally immersed into a rinsing solvent for a selected period of time,

wherein each step i through iv is performed once or more than once, the selected period of time for each step is independently from about 1 second to about 60 minutes, e.g., from about 1 minute to about 30 minutes, and the sequence of steps may be performed once or more than once.

Excellent results are obtained when the process is carried out at room temperature, however, the solutions may be maintained at any useful temperature desired by the practitioner.

A salt of any metal capable of forming an organometallic complex with the present polymers and capable of forming a stable solution in an appropriate solvent may be used. For example, salts of transition metals are used. For example salts of Sc, Ti, V, Cr, Mn, Fe, Co, Ni, Cu, Zn, Ru, Os, Ag, Au, Zr, Mo, W, Rh, Pd or Pt or salts of Al or Sn may be used. For example, excellent results are achieved with divalent metal salts, for example, divalent Co(II), Ni(II) or Zn(II) salts.

A metal salt with any anion may be used. Good results are found with acetate, hexafluorophosphate and metal salts of 2,2′-azino-bis(3-ethylbenzothiazoline-6-sulfonic acid) (ABTS), for example. Excellent results are obtained with hexafluorophosphate and ABTS salts. In a particular embodiment, hexafluorophosphate or ATBS salts of Fe, Co, Ni, Cu, Zn, Ru, Au, Zr, Mo, W, Rh, Pd, Pt are used, for example, hexafluorophosphate or ATBS salts of Co, Ni or Zn, for example Zn hexafluorophosphate.

The exact solvent or mixture of solvents for the solutions of the invention may be comprised of one or more organic solvents and may also comprise water, and the most effective solvent or solvent mixture will vary depending on the salt and/or polymer used. Excellent results are obtained, for example, using a solution of Co, Ni or Zn hexafluorophosphate in a mixture of tetrahydrofuran and dimethylformamide, a mixture of tetrahydrofuran, dimethylformamide and n-hexane, toluene, alcohols and mixtures thereof.

The same solvent or a different solvent may be used in the solution of the π-conjugated polymer of the invention.

The π-conjugated polymer of the invention comprises a repeating unit of the formula

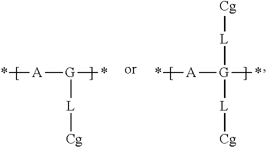

wherein

A is for example a group R—Ar—R wherein each R independently of each other is selected from a direct bond, nitrogen atom, amino group, carbonyl, ethynylene and ethenylene, and

Ar is a substituted or unsubstituted C₆₋₁₈ arylene or substituted or unsubstituted C_{2-C18} heteroarylene, including single ring moieties, fused ring moieties or groups where two or more rings are connected by a direct bond; substituents include groups such as alkyl, amino, amido, cyano, ester, carboxy, hydroxy, alkoxy, alkylcarbonyl etc

or

Ar is a multi-ring system consisting of 2, 3, 4, 5 or 6 C₆₋₁₈ aryl or C2-C18 heteroaryl groups, which may be the same or different and substituted or unsubstituted, wherein each aryl or heteroaryl group is linked to another heteroaryl group by a linking group independently selected from a nitrogen atom, amino group, sulfur atom, carbonyl, ethynylene and ethenylene.

For example, Ar is an unsubstituted or substituted phenyl, biphenyl, naphthyl, fluorene, pyrrole or thiophene group and each R is independently a direct bond, nitrogen atom, ethylene or acetylene.

For example, A is a rigid annulated biphenyl or annulated naphthyl such as

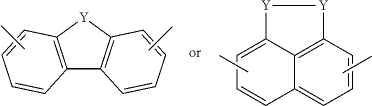

or a group

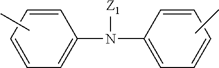

wherein Y is a methylene or substituted methylene, carbonyl or a heteroatom such O, N, S or Si, where N or Si may also be substituted by H, alkyl, alkoxy, alkylcarbonyl and Z, is H, alkyl, aryl, alkyloxycarbonyl etc;

for example, a substituted fluorene such as

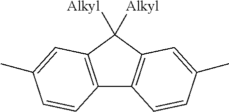

or a carbazole such as

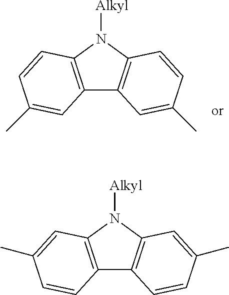

wherein Alkyl is C1-24 alkyl and the π-conjugated polymer of the invention comprises a monomer of the formula

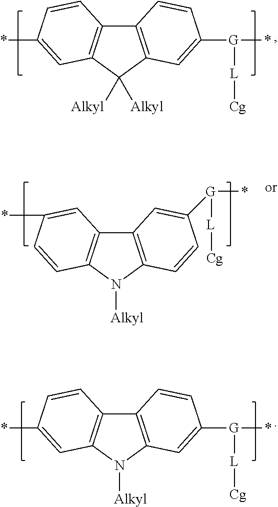

Other groups A or Ar are found in the art and are obvious to the practitioner.

G is for example substituted or unsubstituted C₆₋₁₈ arylene, substituted or unsubstituted C₂₋₁₈ heteroarylene, an ethenylene group or a heteroatom which allows for conjugation of the complexing agent with the polymer backbone such as a nitrogen atom with the proviso that G is not substituted or unsubstituted C₆₋₁₈ arylene when L is a direct bond. For example G is phenylene, naphthylene, or a nitrogen atom, typically G is a nitrogen atom, phenylene or substituted phenylene.

L is for example a direct bond, a non-conjugated linking group such as alkylene, or a conjugated linking group such as R—Ar—R as described above, for example, substituted or unsubstituted C₆₋₁₈ arylene or substituted or unsubstituted C₂₋₁₈ heteroarylene, or L is ethenylene, substituted ethenylene, conjugated C₄₋₈ polyalkenylene, substituted conjugated C₄₋₈ polyalkenylene or alkynylene. For example, L is unsubstituted or substituted phenylene, biphenylene, naphthalene, ethenylene, ethynylene, a pyrrole group, a thiophene group, etc. In one particular embodiment L is phenylene.

Cg is for example a metal complexing agent selected from aniline, pyridine, bipyridine, terpyridine, pyrrole, other polypyridyls and polypyrroles, imidazole such as benzimidazole, Schiff bases in particular aromatic Schiff bases, salicylideneamines, triazoles, diazines, triazines, dipyrrins and phenanthroline as well substituted derivatives of these. For example, Cg is terpyridine, benzimidazole, or terpyridine substituted one or more times by one or more groups selected from C₁₋₈ alkyl C₁₋₈ alkoxy, and C₁₋₈ alkylcarbonyl, typically Cg is unsubstituted terpyridine or terpyridine substituted one or more times by one or more groups selected from C₁₋₈ alkyl. Specific examples of Cg include terpyridyl, dipyrrin and 2,6-bis(1′-methylbenzimidazolyl)pyridyl.

For example, G is a nitrogen atom, L is phenylene, and Cg is terpyridine and the π-conjugated polymer of the invention comprises a repeating unit of the formula

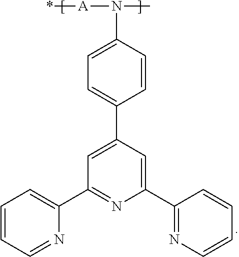

For example, the polymer comprises or consists of the repeating unit

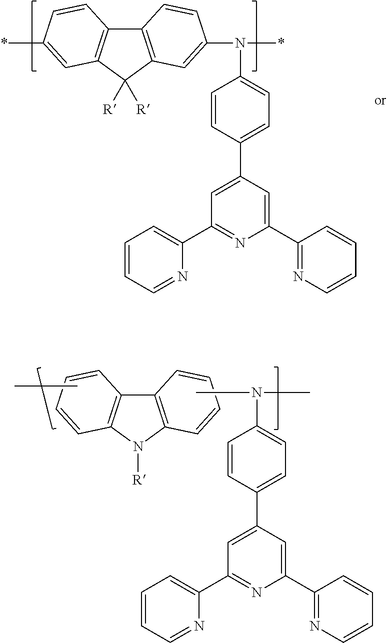

wherein each R′ is independently selected from H, C₁₋₂₄ Alkyl and said alkyl interrupted one or more times by one or more amino, carbonyl, O, S or C₆₋₁₂ arylene and/or substituted one or more times by one or more alkyl, alkylcarbonyl, alkoxy, alkoxycarbonyl, amino, aryl, heteroaryl, cycloalkyl or cycloalkyl interrupted by one or more times by N, NH, N-alkyl, O, S, SO and or SO₂; for example R′ is selected from C₁₋₂₄ Alkyl.

In one particular embodiment, the π-conjugated polymer of the invention comprises or consists of the repeating unit

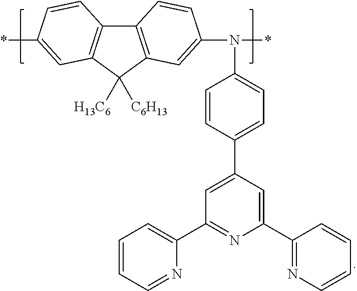

In the present disclosure, reference is made to “substituted” arylene, “substituted” heteroarylene, and other substituents such as “amino groups”, “alkoxy”, etc. More specific definition of these terms is provided here.

Substituents for substituted arylene and substituted heteroarylene are, for example, selected from halogen, OR′, —COOR′, —COOM, —CONR′R′, NO₂, CN, NR′R′, SR′, SO₂R′, SO₃H, SO₂NR′R′; C₁₋₂₄ alkyl, C₂₋₂₄ alkenyl, C₁₋₂₄ alkylcarbonyl, C₃₋₆ cycloalkyl, C₃₋₉ heterocycle, said alkyl, alkenyl, alkylcarbonyl interrupted one or more times by one or more O, NR′, carbonyl, S or SO₂, and/or substituted one or more times by one or more halogen, C₁₋₂₄ alkoxy, C₁₋₂₄ alkylcarbonyl, C₃₋₉ heterocycle, C₆₋₁₈ aryl, —COOR′, —COOM, —CONR′R′, NO₂, CN, NR′R′, SR′, SO₂R′, SO₃H, or SO₂NR′R′; and C₃₋₆ cycloalkyl, C₃₋₉ heterocycle, substituted one or more times by one or more halogen, C₁₋₂₄ alkoxy, C₁₋₂₄ alkylcarbonyl, C₃₋₉ heterocycle, C₆₋₁₈ alkyl, —COOR′, —COOM, —CONR′R′, NO₂, CN, NR′R′, SR′, SO₂R′, SO₃H, or SO₂NR′R′;

each R′ is independently selected from H, C₁₋₂₄ alkyl, C₂₋₂₄ alkenyl, C₁₋₂₄ alkylcarbonyl, C₆₋₁₈ arylene C₂₋₁₈ heteroarylene, C₃₋₆ cycloalkyl, C₃₋₉ heterocycle, said alkyl, alkenyl, alkylcarbonyl interrupted one or more times by one or more O, NH, N(C₁₋₂₄ alkyl), N(C₁₋₂₄ alkylcarbonyl), carbonyl, S or SO₂: said alkyl, alkenyl, alkylcarbonyl, arylene, heteroarylene, C₃₋₆ cycloalkyl, C₃₋₉ heterocycle and said interrupted alkyl, alkenyl, alkylcarbonyl substituted one or more times by one or more halogen, C₁₋₂₄ alkoxy, C₁₋₂₄ alkylcarbonyl, C₃₋₉ heterocycle, C₆₋₁₈ aryl, —COOH, —COO(C₁₋₂₄ alkyl), —COOM, amido, amino, NO₂, CN, S(C₁₋₂₄ alkyl), SO₂(C₁₋₂₄ alkyl), or SO₃H; and

M is an ammonium or metal cation.

As generic substituents, Alkoxy is O-Alkyl or O-Aryl; Amino is NH2, NHAlkyl, NHAryl, N(Alkyl)(Alkyl), N(Aryl)(Alkyl), N(Aryl)(Aryl), or a cyclic amino group; Amido is one of the previous amino groups wherein the N is bound to a carbonyl which carbonyl is bound to the substrate, wherein alkyl and aryl can be gleaned from the above definitions for R′ related to alkyl and aryl groups.

C₁₋₂₄ Alkyl is straight chain or branched alkyl of the specified number of carbon atoms, for example, C₁₋₁₂Alkyl, C₁₋₈ Alkyl and C₁₋₄ Alkyl, and is for example methyl, ethyl, n-propyl, n-butyl, sec-butyl, tert-butyl, n-hexyl, n-octyl, 2-ethylhexyl, tert-octyl, n-nonyl, n-decyl, n-undecyl, n-dodecyl etc.

C₂₋₂₄ alkenyl is a straight or branched chain of the specified number of carbon atoms which chain includes one or more carbon-carbon double bonds, for example, C₂₋₁₂Alkenyl, C₂₋₈ Alkenyl and C₂₋₄ Alkenyl, and is for example ethylene, propylene, butylene etc.

C₁₋₂₄ alkylcarbonyl, is straight chain or branched alkyl of the specified number of carbon atoms, which may also contain carbon-carbon double bonds, wherein the carbon bound to the substrate is a carbonyl, C₁₋₁₂Alkylcarbonyl, C₁₋₈ Alkylcarbonyl and C₁₋₄ Alkylcarbonyl, and is for example formyl, acetyl, propanoyl, acryloyl, etc.

C₃₋₉ saturated or unsaturated heterocycle is a substituted or unsubstituted monocyclic or polycyclic ring of at least 5 atoms, containing 3-9 carbon atoms which heterocycle may also be ionically charged.

Thus, one general embodiment of the invention provides a method for preparing electrochromic films on a substrate comprising a naturally occurring organic polymer, synthetic polymer, metal, mineral, glass or ceramic, which method comprises contacting at least one surface of the substrate with a solution of a metal salt, preferably wherein the metal of the metal salt is Sc, Ti, V, Cr, Mn, Fe, Co, Ni, Cu, Zn, Ru, Os, Ag, Au, Zr, Mo, W, Rh, Pd or Pt, preferably the metal salt is a Zn(II), Ni(II) or Co(II) salt, to produce a metal salt treated surface and in a separate step contacting the metal salt treated surface with a solution of a π-conjugated polymer which polymer comprises a repeating unit of the formula

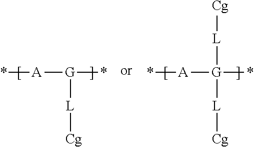

wherein A is a group R—Ar—R wherein each R independently of each other is selected from a direct bond, nitrogen atom, amino group, carbonyl, ethynylene and ethenylene; and Ar is C₆₋₁₈ arylene or C_{2-C18} heteroarylene, or C₆₋₁₈ arylene or C_{2-C18} heteroarylene substituted one or more times by one or more alkyl, amino, amido, cyano, ester, carboxy, hydroxy, alkoxy, alkylcarbony or alkylcarbonyloxy;

or

Ar is a multi-ring system consisting of 2, 3, 4, 5 or 6 C₆₋₁₈ aryl or C₂₋₁₈ heteroaryl groups, which may be the same or different and substituted or unsubstituted as above, wherein each aryl or heteroaryl group is linked to another heteroaryl group by a linking group independently selected from a nitrogen atom, amino group, sulfur atom, carbonyl, ethynylene and ethenylene;

G is C₆₋₁₈ arylene, C₂₋₁₈ heteroarylene, C₆₋₁₈ arylene or C_{2-C18} heteroarylene substituted one or more times by one or more alkyl, amino, amido, cyano, ester, carboxy, hydroxy, alkoxy, alkylcarbony or alkylcarbonyloxy; an ethenylene group or a heteroatom which allows for conjugation of the complexing agent with the polymer backbone with the proviso that G is not substituted or unsubstituted C₆₋₁₈ arylene when L is a direct bond;

L is a direct bond or a group R—Ar—R as described above, or L is ethenylene, substituted ethenylene, conjugated C₄₋₈ polyalkenylene, substituted conjugated C₄₋₈ polyalkenylene or alkynylene; and

Cg is selected from unsubstituted or substituted aniline, pyridine, bipyridine, terpyridine, pyrrole, other polypyridyls, polypyrroles, dipyrrin, imidazole, Schiff bases, salicylideneamines, triazole, diazines and phenanthroline.

Typically, in R—Ar—R, Ar is an unsubstituted or substituted phenyl, biphenyl, naphthyl, fluorene, diphenylamine, pyrrole or thiophene group and each R is independently a direct bond, nitrogen atom, ethylene or acetylene;

G is a nitrogen atom, a phenylene or a substituted phenylene;

L is unsubstituted or substituted phenylene, biphenylene, naphthalene, ethenylene, ethynylene, pyrrole or thiophene; and

Cg is terpyridine, benzimidazole, or terpyridine or benzimidazole substituted one or more times by one or more groups selected from C₁₋₈ alkyl C₁₋₈ alkoxy, and C₁₋₈ alkylcarbonyl.

The polymers of the invention can be prepared, for example, by catalytic coupling of a dihalide and amine:

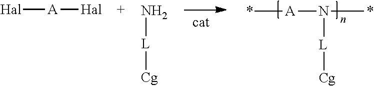

wherein Hal is halogen, for example, Cl, Br or I.

In one particular embodiment, the polymer is a polyiminofluorene with conjugated phenylterpyridine substituent groups formed, for example, by the reaction

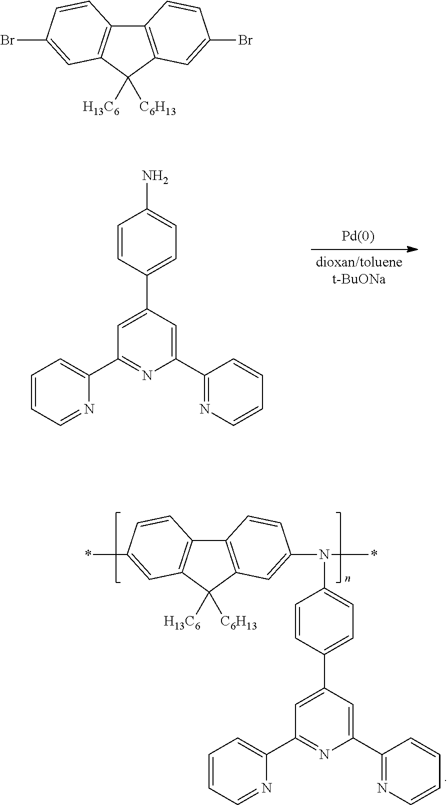

Other methods for making the polymer include, for example, reaction of a dialdehyde with a bis-phosphonium salt:

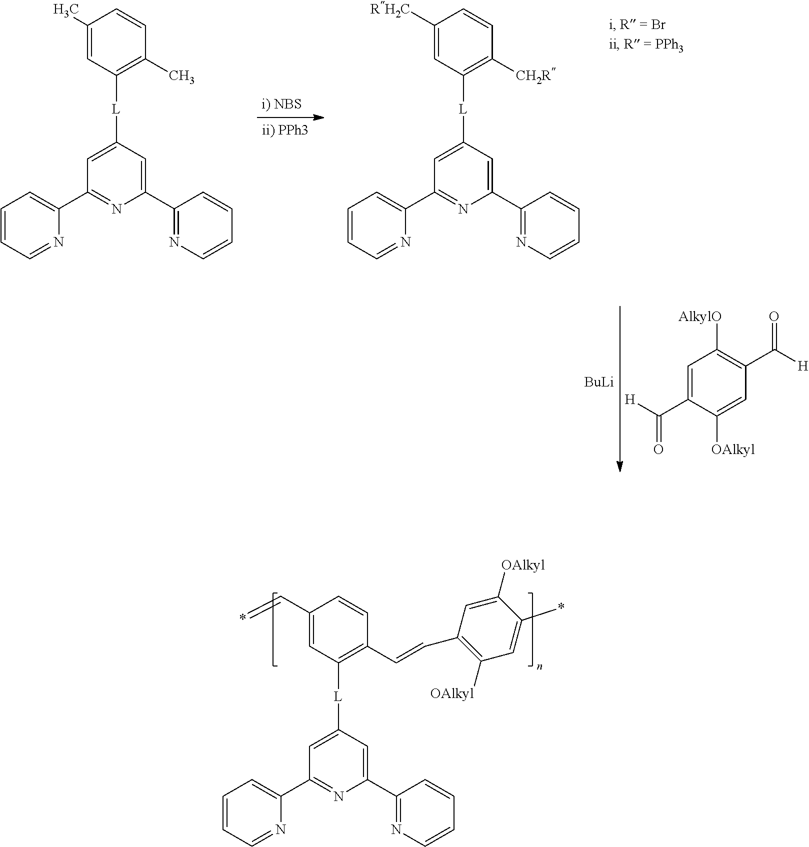

or a Palladium-catalyzed Suzuki-coupling reaction of a 2,5-di(benzimidazolylpyridyl)-substituted 1,4-dibromobenzene and 9,9-dihexylfluorene-2,7-bispinacolatoboronester according to:

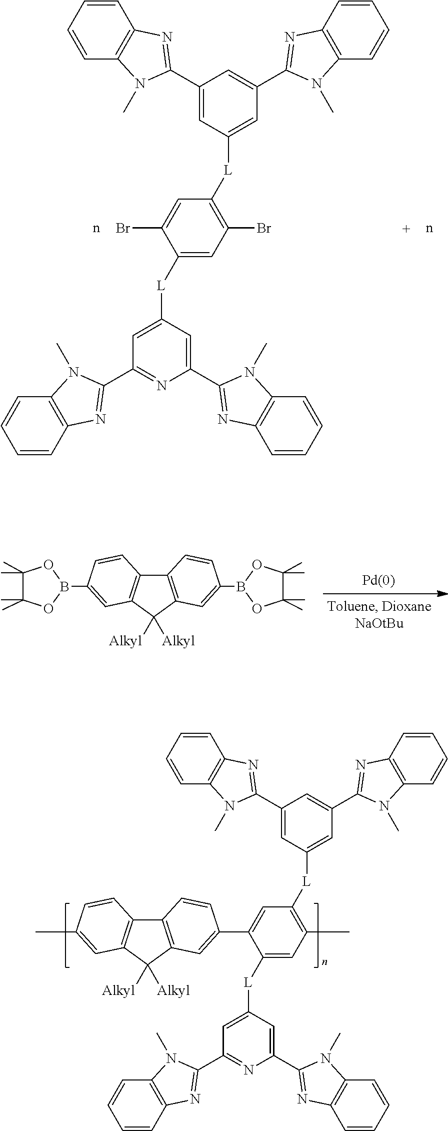

In the examples above, L is not a direct bond.

Procedures for making the portion of the polymer G-L-Cg are found in the literature, for example, U.S. Pat. No. 5,202,423, which is incorporated herein in its entirety by reference.

The steps of the invention are readily carried out under ambient conditions and require no special equipment. It is often preferable to pretreat a substrate, for example quartz, glass or indium tin-oxide (ITO) coated glass, with a polyelectrolyte to form ions on the surface prior to contacting the surface with the solution of metal salt and the solution of π-conjugated polymer. Typically a negatively charged surface is prepared prior to initial immersion into the metal salt solution to make the substrate more receptive to the metal salt. The surface of certain substrates may also undergo additional pretreatments prior to application of the polyelectrolyte layers. Subsequent electrolyte treatments are not necessary or recommended.

For example, quartz substrates are first rigorously cleaned, for example, in a fresh 7:3 mixture of 98% H₂SO₄ and 30% H₂O₂ (caution: the mixture is strongly oxidizing and may detonate upon contact with organic material), washed with water and successively subjected to ultrasonication in alkaline isopropanol, and 0.1 M aqueous HCl at 60° C. for one hour each and washed with water. The cleaned quartz substrate may then be silanized with 3-aminopropylmethyldiethoxysilane in toluene before being coated with polyelectrolyte layers. In one example of a pretreated quartz substrate, three polyelectrolyte layers in the sequence PSS (polystyrene sulfonate), PEI (polyethyleneimine), PSS are applied.

In one example of a pretreated ITO-coated glass substrate, an ITO-coated glass is cleaned using ultrasonication in ethanol and then water after which two polyelectrolyte layers were deposited in the sequence PEI, PSS.

The electrochomic film is then prepared on the substrate. In one example, the pretreated supports are first dipped into a ˜0.001 to ˜0.05 M solution of zinc hexafluorophosphate in a 9:1 (v/v) mixture of tetrahydrofuran (THF) and N,N-dimethylformamide (DMF). The metal ions are adsorbed at the negatively charged surface and the surface charge reverted in the only electrostatic adsorption step in the whole procedure of film formation. After immersion for 10 min, the substrate was removed from the salt solution, washed in a 9:1 v/v mixture of THF/DMF for 30 seconds and in THF for 30 seconds, and subsequently dipped into a 5×10⁻⁵ to 5×10⁻³ monomolar solution of the polymer of Example 1, see Example section, in THF, followed by repeating the two washing steps.

The sequential dipping in solutions of metal salt and polymer leads to complex formation of the tpy groups with the substrate-bound metal ions and the first polymer layer is adsorbed. Repetition of the process (without of course the polyelectrolyte pretreatment) results in gradual adsorption of the coordination polymer films (metal salt plus polymer) with steadily increasing film build.

Profilometry after twelve dipping cycles as above indicates a film thickness of approximately 47 nm, indicating that in each cycle about 4 nm are deposited. Changing the salt alters the rate of film build and other characteristics. The above process is repeated using instead of the zinc hexafluorophosphate solution a similar nickel or cobalt hexafluorophosphate solution. After 12 dipping cycles, the nickel salt provided a pale yellow coordination polymer film 13 nm thick whereas the cobalt slat yielded after 12 dipping cycles a purple coordination polymer film 12 nm thick.

In optimizing the conditions for the various steps of the method, it has been found that the solvent or mixture of solvents used is a very significant factor in the efficiency of the process as shown in the Examples. For example, replacing the solvents in the above zinc hexafluorophosphate/polymer example with a mixture of THF/methanol/n-hexane in a volume ratio 1.5:0.5:2 for the metal salt solution and the washing solutions and a mixture of THF/n-hexane in a volume ratio of 1:1 for the polymer solution gave excellent results with an immersion or dipping time of just 5 seconds and films suitable for electrochromic devices could be obtained after 12 dipping cycles in a total time period of 5 min. In that case the film thickness is 72.4 nm.

Changing the counter ion can also provide a different film. For example a dipping solution of a zinc 2,2′-azino-bis(3-ethylbenzothiazoline-6-sulfonic acid) salt, i.e., Zn(ABTS) in THF/MeOH/n-hexane (1:2:1 v/v) and a 5·10⁻⁴ monomolar ligand dipping solution of the P-FL-TPY polymer in THF/n-hexane (2:1 v/v), provided a yellow film 88 nm thick with different electrochromic properties than the zinc hexafluorophosphate film as illustrated in the examples.

Given that the polymers of the invention all contain aromatic groups, the amount of polymer deposited after each dipping cycle is conveniently measured by UV/Vis absorbance. Thus, the formation of the zinc hexafluorophosphate/polymer complex above can be followed by the UV/visible absorption spectrum of the adsorbed film on quartz where absorption bands at 450, 385, 335 and 292 nm, grow almost linearly in intensity as the number of dipping cycles is increased indicating equal film deposition with each cycle. (The spectra are different from the polymer alone in chloroform solution which shows bands at 405, 276 and 245 nm, but are similar to the spectrum of the zinc complex of the polymer in chloroform with bands at 450, 393, 335 and 283 nm).

Scanning force microscopy (SFM) of the films indicates a smooth and homogeneous surface structure with few aggregates distributed statistically over the substrate. Holes or larger defects are clearly missing.

The metal salts are commercially available or can be conveniently prepared in situ, for example, zinc hexafluorophosphate can be prepared by mixing a solution of zinc acetate with a solution of potassium hexafluorophosphate. The resulting solution can then be used in the method as is. An excess of potassium hexafluorophosphate in such solutions may also be employed.

It is possible to exchange metal ions complexed in the film by other metal ions. For example, if a film consisting of zinc P-FL-TPY is immersed in a solution of iron(II) perchlorate for 20 min, the majority of the zinc(II) ions in the film are replaced by iron(II) ions, the film changing color from yellow to brownish green. If the zinc-based film is dipped into solutions of cobalt(II) or copper(II) acetate, the color changes from yellow to purple or red, respectively.

Thus, the invention also provides a method for preparing electrochromic films on a substrate wherein a coordination polymer containing alternating layers of metal ions and organic ligands, wherein the metal ions of an already prepared coordination polymer are exchanged with an alternate metal ions by exposure of the coordination polymer to a solution of a salt of the alternate metal ion.

The method is especially tailored for metal ion coordination and sequential assembly of electroactive, especially electrochromic, thin films. The π conjugated polymer represents a soluble polytopic ligand with many binding sites along the backbone for metal ion coordination. Metal ion coordination apparently proceeds via cross-linking resulting in an insoluble coordination polymer network which is deposited on a substrate surface through multiple applications of soluble materials. For example:

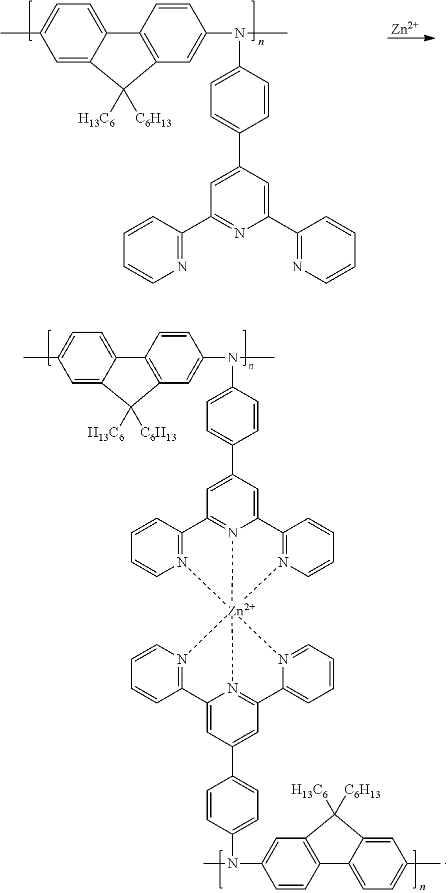

The present invention allows for the design of functional assemblies, in which the functional properties are a consequence of the tailored molecular structure of the supramolecular assembly and provides access to novel functional materials resulting from the combination of tailor-made polymers with transition metal ions, for example, tpy containing polymers complexed with metals. While a great majority of known tpy-based polymers contains the metal-ligand complex in the main chain, very few contain the tpy group in the side chain and only in a very few cases are the polymer chain and substituent groups polyconjugated. However, π-conjugation in main chain and side groups, as in the present invention, is advantageous in order to induce interesting electroactive and chemosensory properties in the materials.

For example, films prepared by the method exhibit UV/vis absorption and fluorescence which are very sensitive to the presence of, for example, metal ions, which can be used as output signal for a chemosensor. It is believed that the fully π-conjugated polymer of the invention may change conjugation upon metal ion coordination producing readily detected changes in absorbance and fluorescence.

The coordination behavior of the polymers is also observed by UV/vis titrations with stepwise addition of aliquots of a metal salt solution. For Example, the metal-free polymer of Example 1

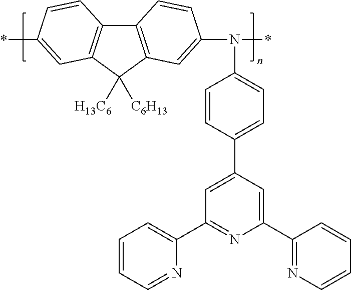

exhibits an intense absorption at 400 nm, presumably arising from the π-π*-transition of the fluorene unit, and two bands at 250 and 280 nm believed to be originating from the phenylterpyridine moiety. Upon addition of a Zn(OAc)₂ solution a broad absorption band around 450 nm is formed and the absorption at 400 nm is gradually diminished and slightly hypsochromically shifted possibly due to reduction of the π-conjugation with the lone electron pair of the backbone nitrogen atom believed to becoming conjugated with the electron withdrawing Zn²⁺-tpy moieties. Similar changes in the UV/vis spectra were also found upon protonation of the terpyridine moiety. The terpyridine absorption bands at 250 and 280 nm are also slightly reduced while the appearance of a new band around 340 nm is observed. Three clear isosbestic points are observed; the endpoint is reached when 0.5 equivalents of Zn²⁺ ions, regarding monomeric units of the polymer of Example 1, are added, i.e., a Zn²⁺:tpy ratio of 1:2 indicating the formation of biscomplexes. Additional Zn(OAc)2 aliquots do not lead to any further changes of the UV/vis-spectrum.

Changes in fluorescence are similarly measured by photoluminescence titration. The solutions of polymer of Example 1 in 25:1 (v/v) THF/methanol show an intense fluorescence, which upon addition of a metal salt is decreased in intensity and shifted to longer wavelengths. For example, the metal-free polymer of Example 1 dissolved in a 25:1 (v/v) mixture of THF/methanol exhibits a broad emission band with maximum at 510 nm using an excitation wavelength of 400 nm. On addition of zinc acetate the fluorescence maximum at 510 nm is drastically diminished and completely quenched as soon as equimolar amounts are added. In addition, a new emission band around 625 nm appears, which becomes the only emissive process after addition of approximately equivalent Zn(OAc)₂. The same results are obtained with excitation at 450 nm.

The metal/coordination polymer matrix produced by the sequential assembly process of the invention exhibit excellent electrochomic properties and exposure to various electric potentials generate remarkable color changes which often vary depending on the metal used.

For example, films of divalent Zn, Co, and Ni hexafluorophosphate ions and the tpy-substituted polymer of Example 1 are formed on ITO-coated glass substrates following the procedure of Example 1 using twelve dipping cycles. Films containing the Zn(II) and Ni(II) ions are yellow in the neutral state and change color to red and finally blue, if anodically oxidized up to 560 mV vs ferrocene standard redox couple (FOC). Films containing Co(II) ions are purple in the neutral state and change color to blue in the oxidized state. All color changes are highly reversible even under ambient conditions. Switching from the neutral to the fully oxidized state is extremely rapid, proceeding within 300 to 700 ms. SEM-pictures indicate a rather homogeneous surface structure, which is retained after electrochemical switching.

The potentials required for the observed color changes are readily determined through a standard spectroelectrochemical analysis, for example, the zinc hexafluorophosphate containing film is yellow in the neutral state and changes color to orange-red at a potential of 310 mV where the first oxidation takes place and turns blue at 560 mV, the second oxidation.

The neutral nickel-containing film is a paler yellow than the zinc-based film and changes color to brownish orange at 410 mV, the first oxidation step; the second oxidation occurs at 560 mV where the film turns blue.

The cobalt containing film is purple in the neutral state and changes to at 310 mV; no other clear color changes are noted.

Switching times for the above films were also measured as described in the Examples using a potential of 560 mV for zinc- and nickel based films and 310 mV for cobalt-based films, and plotting the absorbance at 800 nm versus time. Switching times of 450 ms for the zinc-containing film, and 325 and 500 ms for the cobalt- and nickel-based films were obtained. The differences may partially be due to different thickness reached after twelve dipping cycles when the different metals are used, but differences in film morphology (density, porosity) may also play a role. The switching times are very short, compared to other devices prepared using layer-by-layer assembly.

The present films are also robust, for example, in the above examples, oxidative cycling using cyclic voltammetry at a scan rate of 200 mVs⁻¹ results in the loss in anodic current of only about eight percent after a hundred cycles, even if no care is taken to protect the films against oxygen and humidity.

Different polymer ligands provide films with different characteristics. For example, Zn, Ni, and Co hexafluorophosphate coordination films are prepared as above using the carbazole polymers of Examples 2.

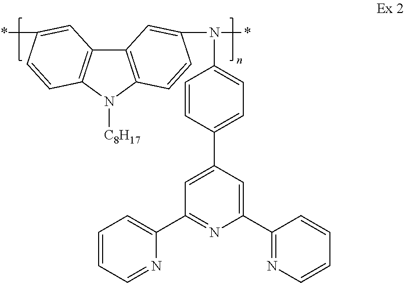

The zinc hexafluorophosphate coordination film prepared using the 3,6-carbazole polymer of example 2 is yellow in the neutral state but changes color to green instead of red at the first oxidation at a potential of 360 mV. The polymer turns blue at the second oxidation, but this occurs at 760 mV instead of 560 mV as seen above. The cobalt film is purple in the neutral state as above, but exhibits two oxidations, one at 460 mV where it turns brown and another at 710 mV where the polymer turns gray. Additional data is found in the Examples.

While not wanting to be bound by theory, in the neutral state, the colors appear to be influenced by different interactions between the d-electron of the metal ions and p-electrons of the terpyridine ligands, which affect the backbone absorption because of the π-conjugation of the side groups. In the fully oxidized state, it appears that the color is dominated by the presence of the dication state and the strong electron delocalization along the backbone causing all films to exhibit the same blue color no matter what kind of metal ions are present in the film.

The method of the instant invention provides a coordinative self-assembly process whereby ultrathin films with electrochromic properties, fast switching time, high contrast, reversibility and high stability are produced without the aid of non-electroactive counter-polyelectrolytes. The metal complexing side chains of the fully π conjugated polymer immobilize the polymer via complex formation with metal ions forming a highly porous and rigid network structure which allows for rapid ion transfer and fast switching time.

The sequential assembly of films is favored by the polyfunctional character of the polymer chains acting as polytopic ligands. After immobilization, the highly functionalized polymer chains provide a high concentration of metal complexing groups at the substrate surface, which again favors the immobilization of metal ions in high concentration and so on. The metal ion coordination of the polymer chains leads to a cross-linked structure and desorption of individual polymer chains becomes highly unlikely. Furthermore, due to the aromatic character of the polymer backbone and the selection of the substituent groups, the coordination polymer network is rather rigid and highly porous which enables rapid ion transfer and fast switching times.

In the metal/polymer complex formed by the invention, i.e. the coordination polymer films, it is believed that electronic interactions between the metal ions and the polymer chains play in generating the different colors of the coordination polymer films in the neutral state, and for differences in the oxidation potential. The ionochromism is advantageous for tuning the color of electrochromic devices and for ion sensing as variation of the metal ions, arylene groups in the polymer backbone, and nature of the ligand units provides films with similar architecture, but different colors, oxidation potentials and switching characteristics.

### Examples

Electrochemical properties of the metal polyiminofluorene-terpyridine coordination films are measured by coating an ITO-coated glass substrate with the coordination film as in examples 5-18 below and using the coated substrate as anode in a conventional three-electrode glass electrochemical cell equipped with platinum reference and platinum counter electrode. The cell is filled with acetonitrile (saturated with N₂) containing 0.1 M tetrabutylammonium hexafluorophosphate as electrolyte salt and oxidation potentials are determined by cyclovoltammetry (CV) measured vs ferrocene (FOC). Electrochromic behavior is measured by monitoring UV absorption spectra while different potentials are applied to the film. Switching times are determined by repeatedly switching on an off, for 5 sec at a time, an applied potential capable of forming the oxidized state (2) (or oxidized state (1) if no other state was detectable), plotting the absorbance at 800 nm versus the time and expanding the time scale for a single oxidation step. Contrast is determined by measuring the change in transmission at 800 nm upon application of a potential leading to oxidized state (2) (or oxidized state (1) if no other state was detectable).

### Example 1

### Synthesis of Polyiminofluorene-Terpyridine (P-FL-TPY)

0.060 g (0.185 mmol) 4′-(p-Aminophenyl)-2,2′:6,2″-terpyridine and 0.093 g (0.18 mmol) 2,7-dibromo-9,9-dihexylfluorene are dissolved under inert conditions in 5 ml toluene/dioxane (3:2) using the Schlenk tube technique. To this solution is added 0.005 g Pd₂(dba)₃, 0.016 g X-Phos and finally 0.054 g (0.56 mmol) sodium t-butoxide. The reaction mixture was filtered under nitrogen at 100° C. for 10 h. After cooling to room temperature the reaction is quenched by the addition of 10 ml aqueous ammonia. The organic phase is diluted with toluene, separated, washed with water several times and then dried over magnesium sulphate. After concentration in vacuo the residue is poured into hexane to precipitate the polymer, which was filtered off, washed with methanol and dried under ambient conditions to yield 0.097 g of the polymer as a lime green powder. ¹H-NMR (300 MHz, CDCl₃, ppm): δ 8.71 (s, 2H; H³′); 8.69 (d, 2H; H⁶); 8.64 (d, 2H; H³); 7.85 (m, 2H; H⁴); 7.79 (d, 2H; H⁸); 7.55 (d, 2H; arom. fluorene); 7.31 m, 2H; H⁵); 2.27 (m, 4H; arom. fluorene); 0.65-1.98 (m, 22H; alkyl chain).

| | Toulene | THF | CH₂Cl₂ |
|---|---|---|---|
| Absorption _{λmax} | 414 nm | 405 nm | 412 nm |
| Emission _{λmax} | 470 nm | 518 nm | 550 nm |
| Φ_{f} | 55% | 43% | 32% |

### Example 2

### Synthesis of Polyimino-3,6-Carbazole-Terpyridine (P-3,6-CBZ-TPY)

0.150 g (0.462 mmol) 4′-(p-Aminophenyl)-2,2′:6,2″-terpyridine and 0.202 g (0.462 mmol) 3,6-dibromo-N-(2-ethylhexyl)carbazole are dissolved under inert conditions in 15 ml dioxane using the Schlenk tube technique. To this solution is added a dioxane solution of 0.010 g (2.5 mol %) Pd₂(dba)₃ and 0.014 g (15 mol %) tri-tert-butylphosphine, and finally 0.133 g (1.38 mmol) sodium t-butoxide. The reaction mixture is filtered under nitrogen at 100° C. for 10 h. After cooling to room temperature the reaction is quenched by the addition of 10 ml aqueous ammonia. The organic phase is diluted with toluene, separated, washed with water several times and then dried over magnesium sulphate. After concentration in vacuo the residue is poured into hexane to precipitate the polymer, which is filtered off, washed with methanol and dried under ambient conditions to yield. 0.221 g of the polymer as a lime green powder. ¹H-NMR (300 MHz, CDCl₃): δ (ppm) 0.8-2.1 (alkyl chain); 4.1 (Cbz N—CH₂); 6.95-7.1 (Cbz and phenylene arom. H); 7.3 (TPY arom. H); 7.35 (Cbz arom. H); 7.7 (phenylene arom H); 7.85 (TPY arom H); 8.63 (TPY arom H); 8.67 (TPY arom H); 8.7 (TPY arom H).

| | Toulene | THF | CH₂Cl₂ |
|---|---|---|---|
| Absorption _{λmax} | 365 nm | 370 nm | 360 nm |
| Emission _{λmax} | 492 nm | 537 nm | 573nm |
| Φ_{f} | 63% | 34% | 12% |

### Example 3

### Synthesis of Polyimino-2,7-Carbazole-Terpyridine (P-2,7-CBZ-TPY)

0.050 g (0.154 mmol) 4′-(p-Aminophenyl)-2,2′:6,2″-terpyridine and 0.067 g (0.154 mmol) 2,7-dibromo-N-(2-ethylhexyl)carbazole are dissolved under inert conditions in 5 ml toluene using the Schlenk tube technique. To this solution is added a toluene solution of 0.0035 g (3.85 μmol) Pd₂(dba)₃ and 0.0047 g (0,023 mmol) tri-tert-butylphosphine, and finally 0.044 g (0.462 mmol) sodium t-butoxide. The reaction mixture is filtered under nitrogen at 100° C. for 18 h. After cooling to room temperature the reaction is quenched by the addition of 5 ml water. The organic phase is washed with saturated solution of sodium chloride several times, filtered above celite and then dried over magnesium sulphate. After concentration in vacuo the residue is poured into hexane to precipitate the polymer, which is filtered off, washed with hexane and dried under ambient conditions to yield 0.062 g of the polymer as a yellow green powder. ¹H-NMR (300 MHz, C₆D₆) δ (ppm) 0.6-2 (alkyl chain); 3.6-3.9 (Cbz N—CH₂); 6.9 (Cbz arom. H); 6.95-7.1 (Cbz und phenylene arom. H); 7.5 (TPY arom. H); 7.72 (TPY und phenylene arom. H); 8.05 (Cbz arom. H); 8.73 (TPY arom. H); 8.93 (TPY arom. H); 9.38 (TPY arom. H).

| | Toulene | THF | CH₂Cl₂ |
|---|---|---|---|
| Absorption _{λmax} | 376 nm | 380 nm | 374 nm |
| Emission _{λmax} | 457 nm | 466 rim | 480 nm |
| Φ_{f} | 68% | 48% | 33% |

### Example 4

### Synthesis of Polyimino-Bocdiphenylamine-Terpyridine (P-BocDA-TPY)

0.070 g (0.216 mmol) 4′-(p-Aminophenyl)-2,2′:6,2″-terpyridine and 0.092 g (0.216 mmol) tert-butyl bis(4-bromophenyl)carbamate are dissolved under inert conditions in 5 ml toluene using the Schlenk tube technique. To this solution is added a toluene solution of 0.00494 g (5.39 μmol) Pd₂(dba)₃ and 0.00647 g (0.0326 mmol) tri-tert-butylphosphine, and finally 0.062 g (0.647 mmol) sodium t-butoxide. The reaction mixture is filtered under nitrogen at 95° C. for 21 h. After cooling to room temperature the reaction is quenched by the addition of 10 ml aqueous ammonia. The organic phase is washed with saturated solution of sodium chloride several times and then dried over magnesium sulphate. After concentration in vacuo the residue was poured into hexane to precipitate the polymer, which was filtered off, washed with hexane and dried under ambient conditions to yield. 0.112 g of the polymer as a yellow green powder. ¹H-NMR (300 MHz, C₆D₆) δ (ppm) 1-1.5 (alkyl chain); 6.81 (phenylene arom. H); 6.97 (phenylene arom. H); 7.08 (phenylene arom. H); 7.23 (phenylene arom. H); 7.38 (phenylene arom. H); 7.57 (TPY arom. H); 8.65 (TPY arom. H); 8.78 (TPY arom. H); 9.2 (TPY arom. H).

| | Toulene | THF | CH₂Cl₂ |
|---|---|---|---|
| Absorption _{λmax} | 367 nm | 370 nm | 367 nm |
| Emission _{λmax} | 456 nm | 487 nm | 508 nm |
| Φ_{f} | 68% | 55% | 40% |

### Example 5

### Pretreatment of Substrates for Film Deposition

Quartz substrates (30×12×1 mm³) are cleaned in a fresh piranha solution (7:3 mixture of 98% H₂SO₄/30% H₂O₂; caution: The mixture is strongly oxidizing and may detonate upon contact with organic material), washed with MILLI-Q water and successively subjected to ultrasonication in alkaline isopropanol, and 0.1 M aqueous HCl at 60° C. for one hour each. Then, after careful washing with MILLI-Q water, the substrates are silanized with 3-aminopropylmethyldiethoxysilane in toluene, and finally coated with three polyelectrolyte layers in the sequence PSS (polystyrene sulfonate), PEI (polyethyleneimine), PSS (e.g., as in Adv. Mater. 2001, 13, 1188).

ITO-coated glass substrates are cleaned by ultrasonication in ethanol and water at 60° C. for 30 min each after which two polyelectrolyte layers are deposited in the sequence PEI-PSS.

ALTHOUGH the following procedures recite coating pretreated ITO-coated glass substrates in the formation of the coordination films, both the pretreated quartz and ITO-coated glass substrates are used with equal results.

### Example 6

### Preparation of Comparative Zinc(PF₆)-Polyiminofluorene-Terpyridine Coordination Polymer Film (Zn(PF₆)-P-FL-TPY)

Method a)

Identical volumes of a 0.02 M solution of potassium hexafluorophosphate in THF/DMF (9:1 v/v) and a 0.01 M solution of zinc acetate in THF/DMF (9:1 v/v) are mixed to prepared a zinc hexafluorophosphate dipping solution in THF/DMF (9:1 v/v). A 5·10⁻⁴ monomolar ligand dipping solution of the P-FL-TPY polymer of Example 1 in THF is also prepared.

The pretreated ITO coated glass substrate from Example 5 is dipped sequentially into (a) the THF/DMF solution of zinc hexafluorophosphate, (b) THF/DMF (9:1 v/v), (c) THF, (d) the THF solution of the P-FL-TPY polymer of Example 1, (e) THF, (f) THF/DMF (9:1 v/v), and the sequence (a)-(f) is repeated. Immersion times are 10 min each for steps (a) and (d) and 30 s for steps (b), (c), (e) and (f). With each dipping into the zinc salt or polymer solution, the substrate is coated with a thin layer of the zinc salt or polymer respectively. After 12 dipping cycles a yellow coordination polymer film of 47 nm in thickness is obtained. UV/Vis spectra indicate absorption maxima at 450, 385, 335 and 292 nm, the absorbance at 375 nm being about 0.7. Peak oxidation potentials vs. FOC are found for the film at 310 mV where the color turns red and 560 mV where the color is blue.

Method b)

Identical volumes of a 0.02 M solution of potassium hexafluorophosphate in THF/DMF/MeOH/n-hexane (1:0.01:0.5:1 v/v) and a 0.01 M solution of zinc acetate in THF/DMF/MeOH/n-hexane (1:0.01:0.5:1 v/v) are mixed to prepared a zinc hexafluorophosphate dipping solution. A 5·10⁻³ monomolar ligand dipping solution of the P-FL-TPY polymer of Example 1 in THF/MeOH/n-hexane (1.5:0.5:2 v/v) is prepared. The pretreated ITO coated glass substrate from Example 5 Is dipped sequentially into (a) the THF/DMF/MeOH/n-hexane (1:0.01:0.5:1 v/v) solution of zinc hexafluorophosphate, (b) pure THF/MeOH/n-hexane (1.5:0.5:2 v/v), (c) pure THF/MeOH/n-hexane (1.5:0.5:2 v/v), (d) the THF/MeOH/n-hexane (1.5:0.5:2 v/v) solution of P-FL-TPY, (e) pure THF/MeOH/n-hexane (1.5:0.5:2 v/v), (f) pure THF/MeOH/n-hexane (1.5:0.5:2 v/v), and the sequence (a)-(f) is repeated. Immersion times were 5 sec each for all steps. After 12 dipping cycles a coordination polymer film of 110 nm in thickness is obtained. UV/Vis spectra indicate absorption maxima at 450, 385, 335 and 292 nm, the absorbance at 375 nm being about 0.36.

Method c)

Identical volumes of a 0.02 M solution of potassium hexafluorophosphate in toluene/DMF (9:1 v/v) and a 0.01 M solution of zinc acetate in toluene/DMF (9:1 v/v) are mixed to prepared a zinc hexafluorophosphate dipping solution. A 5·10⁻⁴ monomolar solution of the P-FL-TPY polymer of Example 1 in toluene are prepared in a manner similar to that of method a) substituting toluene for THF.

The pretreated ITO coated glass substrate from Example 5 is dipped sequentially into (a) the toluene/DMF (9:1 v/v) solution of zinc hexafluorophosphate, (b) pure toluene/DMF (9:1 v/v), (c) pure toluene, (d) the toluene solution of the P-FL-TPY polymer of Example 1, (e) pure toluene, (f) pure toluene, and the sequence (a)-(f) is repeated. Immersion times are 10 min each for steps (a) and (d) and 30 s for steps (b), (c), (e) and (f). After 12 dipping cycles a coordination polymer film of 56 nm in thickness is obtained. UV/Vis spectra indicate absorption maxima at 450, 385, 335 and 292 nm, the absorbance at 375 nm being about 0.9.

Method d)

Identical volumes of a 0.02 M solution of potassium hexafluorophosphate in toluene/DMF/MeOH/n-hexane (1:0.1:0.9:1 v/v) and a 0.01 M solution of zinc acetate in toluene/DMF/MeOH/n-hexane (1:0.1:0.9:1 v/v) are mixed to prepared a zinc hexafluorophosphate dipping solution. A 5·10⁻⁴ monomolar solution of the P-FL-TPY polymer of Example 1 in toluene/n-hexane (1:1 v/v) are prepared in a manner similar to that of method a) by substituting the solvents used.

The pretreated ITO coated glass substrate from Example 5 is dipped sequentially into (a) the toluene/DMF/MeOH/n-hexane (1:0.1:0.9:1 v/v) solution of zinc hexafluorophosphate, (b) pure toluene/MeOH/n-hexane (1:0.9:1 v/v), (c) pure toluene/MeOH/n-hexane (1:0.9:1 v/v), (d) the toluene/n-hexane (1: v/v) solution of P-FL-TPY, (e) pure toluene/n-hexane (1:1 v/v), (f) pure toluene/n-hexane (1:1 v/v) and the sequence (a)-(f) is repeated. Immersion times are 10 min each for steps (a) and (d) and 30 s for steps (b), (c), (e) and (f). After 12 dipping cycles a coordination polymer film of 228 nm in thickness is obtained, UV/Vis spectra indicate absorption maxima at 450, 385, 335 and 292 nm, the absorbance at 375 nm being about 0.65.

### Example 7

### Preparation of Zinc(ABTS)-Polyiminofluorene-Terpyridine Coordination Polymer Film (Zn(ABTS)-P-FL-TPY)

A dipping solution of 2,2′-azino-bis(3-ethylbenzothiazoline-6-sulfonic acid)zinc salt, i.e., Zn(ABTS), is prepared by mixing identical volumes of a 0.01 M solution of (ABTS)diammonium salt in THF/MeOH/n-hexane (1:2:1 v/v) with a 0.01 M solution of zinc acetate in THF/MeOH/n-hexane (1:2:1 v/v). A 5·10⁻⁴ monomolar ligand dipping solution of the P-FL-TPY polymer of Example 1 in THF/n-hexane (2:1 v/v) is also prepared.

The pretreated ITO coated glass substrate from Example 5 is dipped sequentially into (a) the THF/MeOH/n-hexane (1:2:1 v/v) solution of zinc ABTS, (b) THF/MeOH/n-hexane (1:2:1 v/v), (c) THF/MeOH/n-hexane (1:2:1 v/v), (d) the THF/n-hexane (2:1 v/v) solution of P-FL-TPY in THF/n-hexane (2:1 v/v), (e) THF/n-hexane (2:1 v/v), (f) THF/n-hexane (2:1 v/v), and the sequence (a)-(f) is repeated. Immersion times are 5 min each for steps (a) and (d) and 5 s for steps (b), (c), (e) and (f). After 12 dipping cycles a coordination polymer film of 88 nm in thickness is obtained. UV/Vis spectra indicate absorption maxima at 470, 348 and 290 nm, the absorbance at 348 nm being about 0.5. Peak oxidation potentials vs. FOC are found for the film at 210 mV where the color turns gray/brown and 640 mV where the color is blue.

### Example 8

### Preparation of Nickel(PF₆)-Polyiminofluorene-Terpyridine Coordination Polymer Film (Ni(PF₆)-P-FL-TPY)

A dipping solution of nickel hexafluorophosphate is prepared by mixing identical volumes of a 0.02 M solution of potassium hexafluorophosphate in THF/DMF (9:1 v/v) with a 0.01 M solution of nickel(II)acetate in THF/DMF (9:1 v/v). The procedure of Example 6 is repeated using the nickel hexafluorophosphate dipping solution in place of the zinc hexafluorophosphate solution and a 5·10⁻⁴ monomolar ligand dipping solution of the P-FL-TPY polymer of Example 1 in THF. After 12 cycles a pale yellow coordination polymer film of 13 nm is obtained. Peak oxidation potentials vs. FOC are found for the film at 410 mV where the color turns brown/orange and 560 mV where the color is blue.

### Example 9

### Preparation of Cobalt(PF₆)-Polyiminofluorene-Terpyridine Coordination Polymer Film (Co(PF₆)-P-FL-TPY)

A dipping solution of cobalt hexafluorophosphate is prepared by mixing identical volumes of a 0.02 M solution of potassium hexafluorophosphate in THF/DMF (9:1 v/v) with a 0.01 M solution of cobalt(II)acetate in THF/DMF (9:1 v/v). The procedure of Example 6 is repeated using the cobalt hexafluorophosphate dipping solution in place of the zinc hexafluorophosphate solution and a 5·10⁻⁴ monomolar ligand dipping solution of the P-FL-TPY polymer of Example 1 in THF. After 12 cycles a purple coordination polymer film of 12 nm is obtained. One peak oxidation potential vs. FOC is found for the film at 310 mV where the color is blue.

### Example 10

### Preparation of Zinc(PF₆)-Polyimino-3,6-Carbazole-Terpyridine Coordination Polymer Film (Zn(PF₆)-P-3,6-CBZ-TPY)

A dipping solution of zinc hexafluorophosphate is prepared by mixing identical volumes of a 0.2 M solution of potassium hexafluorophosphate in THF/DMF/n-hexane (1:0.1:1 v/v) with a 0.01 M solution of zinc acetate in THF/DMF/n-hexane (1:0.1:1 v/v). A 5·10⁻⁴ monomolar ligand dipping solution of the P-3,6-CBZ-TPY polymer of Example 2 in THF/n-hexane (1:1 v/v) is also prepared.

The pretreated ITO coated glass substrate from Example 5 is dipped sequentially into (a) the THF/DMF/n-hexane (1:0.1:1 v/v) solution of zinc hexafluorophosphate, (b) THF/n-hexane (1:1 v/v), (c) THF/n-hexane (1:1 v/v), (d) the THF/n-hexane (1:1 v/v) solution of P-3,6-CBZ-TPY of Example 2 in THF/n-hexane (1:1 v/v), (e) THF/n-hexane (1:1 v/v), (f) THF/n-hexane (1:1 v/v), and the sequence (a)-(f) is repeated. Immersion times are 10 min each for steps (a) and (d) and 30 s for steps (b), (c), (e) and (f). After 12 dipping cycles a yellow coordination polymer film of 48 nm in thickness is obtained. UV/Vis spectra indicate absorption maxima at 450, 330 and 290 nm, the absorbance at 290 nm being about 0.85. Peak oxidation potentials vs. FOC are found for the film at 360 mV where the color turns green and 760 mV where the color is blue.

### Example 11

### Preparation of Nickel(PF₆)-Polyimino-3,6-Carbazole-Terpyridine Coordination Polymer Film (Ni(PF₆)-P-3,6-CBZ-TPY)

The procedure of Example 10 is repeated substituting nickel(II)acetate for zinc acetate in the preparation of the Metal(PF₆) dipping solution. After 12 dipping cycles a coordination polymer film of 19 nm in thickness is obtained. Peak oxidation potentials vs. FOC are found for the film at 310 mV where the color turns green and 560 mV where the color is blue.

### Example 12

### Preparation of Cobalt(PF₆)-Polyimino-3,6-Carbazole-Terpyridine Coordination Polymer Film (Co(PF₆)-P-3,6-CBZ-TPY)

The procedure of Example 10 is repeated substituting cobalt(II)acetate for zinc acetate in the preparation of the Metal(PF₆) dipping solution. After 12 dipping cycles a purple coordination polymer film of 23 nm in thickness is obtained. Peak oxidation potentials vs. FOC are found for the film at 460 mV where the color turns brown and 710 mV where the color is gray.

### Example 13

### Preparation of Nickel(PF₆)-Polyimino-2,7-Carbazole-Terpyridine Coordination Polymer Film (Ni(PF₆)-P-2,7-CBZ-TPY)

A dipping solution of nickel hexafluorophosphate is prepared by mixing identical volumes of a 0.2 M solution of potassium hexafluorophosphate in THF/DMF/n-hexane (1:0.1:1 v/v) with a 0.01 M solution of nickel acetate in THF/DMF/n-hexane (1:0.1:1 v/v). A 5·10⁻⁴ monomolar ligand dipping solution of the P-2,7-CBZ-TPY polymer of Example 3 in THF/n-hexane (1:1 v/v) is also prepared.

The pretreated ITO coated glass substrate from Example 5 is dipped sequentially into (a) (a) the THF/DMF/n-hexane (1:0.1:1 v/v) solution of nickel hexafluorophosphate, (b) THF/n-hexane (1:1 v/v), (c) THF/n-hexane (1:1 v/v), (d) the THF/n-hexane (1:1 v/v) solution of P-2,7-CBZ-TPY in THF/n-hexane (1:1 v/v), (e) THF/n-hexane (1:1 v/v), (f) THF/n-hexane (1:1 v/v), and the sequence (a)-(f) is repeated. Immersion times are 2 min each for steps (a) and (d) and 5 s for steps (b), (c), (e) and (f). After 12 dipping cycles a yellow coordination polymer film of 54 nm in thickness was obtained. UV/Vis spectra indicate absorption maxima at 460, 330 and 275 nm, the absorbance at 275 nm being about 0.53. Peak oxidation potentials vs. FOC are found for the film at 560 mV where the color turns gray/green and 760 mV where the color is gray/green.

### Example 14

### Preparation of Zinc(PF₆)-Polyimino-2,7-Carbazole-Terpyridine Coordination Polymer Film (Zn(PF₆)-P-2,7-CBZ-TPY)

The procedure of Example 13 is repeated substituting zinc acetate nickel(II)acetate for nickel(II)acetate in the preparation of the Metal(PF₆) dipping solution. After 12 dipping cycles a yellow coordination polymer film of 39 nm in thickness is obtained. Peak oxidation potentials vs. FOC are found for the film at 660 mV where the color turns gray and 1060 mV where the color is gray.

### Example 15

### Preparation of Cobalt(PF₆)-Polyimino-2,7-Carbazole-Terpyridine Coordination Polymer Film (Co(PF₆)-P-2,7-CBZ-TPY)

The procedure of Example 13 is repeated substituting cobalt(II)acetate for zinc acetate in the preparation of the Metal(PF₆) dipping solution. After 12 dipping cycles a purple coordination polymer film of 29 nm in thickness is obtained. One peak oxidation potential vs. FOC is found for the film at 710 mV where the color turns brown.

### Example 16

### Preparation of Zinc Polyimino-BocDiphenylamine-Terpyridine (P-BocDA-TPY) Coordination Polymer Film

A dipping solution of zinc hexafluorophosphate is prepared by mixing identical volumes of a 0.2 M solution of potassium hexafluorophosphate in THF/DMF/MeOH/n-hexane (1:0.01:0.5:1 v/v) with a 0.1 M solution of zinc acetate in THF/DMF/MeOH/n-hexane (1:0.01:0.5:1 v/v). A 5·10⁻⁴ monomolar ligand dipping solution of the P-BocDA-TPY polymer of Example 4 in THF/n-hexane (1:1 v/v) is also prepared.

The pretreated ITO coated glass substrate from Example 5 is dipped sequentially into (a) the THF/DMF/MeOH/n-hexane (1:0.01:0.5:1 v/v) solution of zinc hexafluorophosphate, (b) THF/MeOH/n-hexane (1.5:0.5:1 v/v), (c) THF/MeOH/n-hexane (1.5:0.5:1 v/v), (d) the THF/n-hexane (1:1 v/v) solution of the P-BocDA-TPY polymer of Example 4 in THF/n-hexane (1:1 v/v), (e) THF/n-hexane (1:1 v/v), (f) THF/n-hexane (1:1 v/v) and the sequence (a)-(f) is repeated. Immersion times are 5 min each for steps (a) and (d) and 5 s for steps (b), (c), (e) and (f). After 12 dipping cycles a lime green coordination polymer film of 41 nm in thickness is obtained. UV/Vis spectra indicate absorption maxima at 447, 330, 295, 248 and 216 nm, the absorbance at 330 nm being about 0.35. Peak oxidation potential vs, FOC at 780 mV where the color turns gray/green.

### Example 17

### Preparation of a Film of Zinc-P-DA-Tpy Coordination Polymer Upon Elimination of Boc-Group

The procedure of Example 16 is repeated to generate a lime-green film on the substrate. The coated substrate is annealed in a dry box at 180° C. for 40 min. The lime-green film changes color to brownish yellow. Complete removal of the boc-group in the annealed film is determined by the absence of the C═O bands at 1706 cm⁻¹ and 1640 cm⁻¹. UV/Vis spectra indicate absorption maxima at 453, 335, 295, 248 and 216 nm. Peak oxidation potentials vs. FOC are found for the film at 180 mV where the color turns dark gray and 870 mV where the color is dark gray.

### Example 18

### Preparation of Iron-P-Fl-Tpy Coordination Polymer Film

The zinc P-FL-TPY coated substrate of Example 6, method a) is dipped into 0.01 M solution of iron(II) perchlorate in THF/MeOH/n-hexane (5:1:4 v/v) for 20 min. The yellowish film changes in color to brownish green. UV/Vis spectra indicate absorption maxima at 780, 445, 338 and 295 nm. The EDX analysis indicates that 58.3 weight % of iron and 41.7 weight % of zinc are present in the coordination polymer film.

TABLE 1
Electrochromic switching data of self-assembled films (12 dipping cycles).

| | Color of films | | | Switch | contrast |
|---|---|---|---|---|---|
| Ex/ | neutral | oxidized | oxidized | Time | Δ% T at |
| Metal | state | state (1) | state (2) | [s] | 800 nm |
| 6a Zn | yellow | red | blue | 0.450 | 18 |
| 9 Co | purple | blue | | 0.325 | 8.5 |
| 8 Ni | yellow | brownish orange | blue | 0.500 | 5 |
| 7 Zn | yellow | grayish brown | blue | 0.380 | 33 |
| (ABTS) | | | | | |
| 10 Zn | yellow | green | blue | 0.300 | 4 |
| 12 Co | purple | brown | gray | 1.100 | 2.8 |
| 11 Ni | yellow | green | blue | 0.400 | 3 |
| 14 Zn | yellow | gray | | 0.750 | 6.4 |
| 15 Co | purple | brown | | 0.650 | 5 |
| 13 Ni | yellow | grayish green | grayish green | 0.600 | 3.6 |

| | | | | |
|---|---|---|---|---|
| 16 Zn | lime- | grayish green | n.d. | n.d. |
| | green | | | |
| 17 Zn | Brown/ | dark gray | n.d. | n.d. |
| | yellow | | | |

1. A method for preparing electrochromic films on a substrate which substrate comprises a material selected from the group consisting of a naturally occurring organic polymer, synthetic polymer, metal, mineral, glass and ceramic, which method comprises contacting at least one surface of the substrate with a solution of a metal salt to produce a metal salt treated surface and in a separate step contacting the metal salt treated surface with a solution of a π-conjugated polymer which polymer comprises a repeating unit of the formula 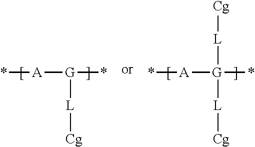
wherein A is a group R—Ar—R wherein each R independently of each other is selected from a direct bond, nitrogen atom, amino group, carbonyl, ethynylene and ethenylene; and Ar is C₆₋₁₈ arylene or C_{2-C18} heteroarylene, or C₆₋₁₈ arylene or C_{2-C18} heteroarylene substituted one or more times by one or more alkyl, amino, amido, cyano, ester, carboxy, hydroxy, alkoxy, alkylcarbony or alkylcarbonyloxy;
or
Ar is a multi-ring system consisting of 2, 3, 4, 5 or 6 C₆₋₁₈ aryl or C₂₋₁₈ heteroaryl groups, which may be the same or different and substituted or unsubstituted as above, wherein each aryl or heteroaryl group is linked to another heteroaryl group by a linking group independently selected from a nitrogen atom, amino group, sulfur atom, carbonyl, ethynylene and ethenylene;
G is C₆₋₁₈ arylene, C₂₋₁₈ heteroarylene, C₆₋₁₈ arylene or C_{2-C18} heteroarylene substituted one or more times by one or more alkyl, amino, amido, cyano, ester, carboxy, hydroxy, alkoxy, alkylcarbony or alkylcarbonyloxy; an ethenylene group or a heteroatom which allows for conjugation of the complexing agent with the polymer backbone with the proviso that G is not substituted or unsubstituted C₆₋₁₈ arylene when L is a direct bond;
L is a direct bond or a group R—Ar—R as described above, or L is ethenylene, substituted ethenylene, conjugated C₄₋₈ polyalkenylene, substituted conjugated C₄₋₈ polyalkenylene or alkynylene; and
Cg is selected from unsubstituted or substituted aniline, pyridine, bipyridine, terpyridine, pyrrole, other polypyridyls, polypyrroles, dipyrrin, imidazole, schiff bases, salicylideneamines, triazole, diazines and phenanthroline.

2. The method according to claim 1 wherein
in R—Ar—R, Ar is an unsubstituted or substituted phenyl, biphenyl, naphthyl, fluorene, diphenylamine, pyrrole or thiophene group and each R is independently a direct bond, nitrogen atom, ethylene or acetylene;
G is a nitrogen atom, a phenylene or a substituted phenylene;
L is unsubstituted or substituted phenylene, biphenylene, naphthalene, ethenylene, ethynylene, pyrrole or thiophene; and
Cg is terpyridine, benzimidazole, or terpyridine or benzimidazole substituted one or more times by one or more groups selected from C₁₋₈ alkyl C₁₋₈ alkoxy, and C₁₋₈ alkylcarbonyl.

3. The method according to claim 1 wherein the metal of the metal salt is Sc, Ti, V, Cr, Mn, Fe, Co, Ni, Cu, Zn, Ru, Os, Ag, Au, Zr, Mo, W, Rh, Pd or Pt.

4. The method according to claim 1 wherein the substrate upon which the film is prepared comprises a thermoplastic polymer, quartz, glass or metal.

5. The method according to claim 4 wherein the substrate upon which the film is prepared is quartz, glass or glass upon which is layered a metal containing material such as indium tin oxide.

6. The method according to claim 1 wherein the surface of the substrate upon which the film is prepared is first pretreated with polyelectrolytes to form ions on the surface.

7. The method according to claim 6 wherein one or more polyelectrolyte layers of polystyrene sulfonate and/or polyethyleneimine are applied to the surface of the substrate to prepare a negatively charged surface.

8. The method according to claim 3 wherein the metal salt is a hexafluorophosphate or a 2,2′-azino-bis(3-ethylbenzothiazoline-6-sulfonic acid salt.

9. The method according to claim 8 wherein the metal salt is a Zn(II), Ni(II) or Co(II) salt.

10. The method according to claim 1 comprising a sequence of steps i) through iv) wherein the substrate is
i) immersed into the solution of a metal salt for a selected period of time, removed, then
ii) immersed into a rinsing solvent for a selected period of time, removed, then
iii) immersed into the solution of the a π-conjugated polymer for a selected period of time, removed, then
iv) optionally immersed into a rinsing solvent for a selected period of time,
wherein each step i through iv is performed once or more than once, the selected period of time for each step is independently from about 1 second to about 60 minutes, and the sequence of steps is performed once or more than once.

11. The method according to claim 10 wherein the selected period of time for each step is independently from about 1 minute to about 30 minutes.

12. The method according to claim 10 wherein the substrate upon which the film is prepared comprises a thermoplastic polymer, quartz, glass or metal and the metal of the metal salt is Sc, Ti, V, Cr, Mn, Fe, Co, Ni, Cu, Zn, Ru, Os, Ag, Au, Zr, Mo, W, Rh, Pd or Pt.

13. The method according to claim 12 wherein the substrate upon which the film is prepared is quartz, glass or glass upon which is layered a metal containing material such as indium tin oxide.

14. The method according to claim 10 wherein the surface of the substrate upon which the film is prepared is first pretreated with polyelectrolytes to form ions on the surface.

15. The method according to claim 14 wherein one or more polyelectrolyte layers of polystyrene sulfonate and/or polyethyleneimine are applied to the surface of the substrate to prepare a negatively charged surface.

16. The method according to claim 10 wherein the metal salt is a hexafluorophosphate or a 2,2′-azino-bis(3-ethylbenzothiazoline-6-sulfonic acid salt.

17. The method according to claim 16 wherein the metal salt is a Zn(II), Ni(II) or Co(II) salt.

18. A method for preparing electrochromic films on a substrate wherein a coordination polymer containing alternating layers of metal ions and organic ligands, which method comprises the step wherein the metal ions of an already prepared coordination polymer are exchanged with alternate metal ions by exposure of the coordination polymer to a solution of a salt of the alternate metal ion.

19. The electrochromic film obtained according to the method of claim 1.

20. The coated substrate obtained according to the method of claim 1.
